(19) United States
(12) Patent Application Publication
(10) Pub. No.: US 2024/0289733 A1
(43) Pub. Date: Aug. 29, 2024

(54) LARGE LANGUAGE MODEL INTERFACE FOR SUPPLY CHAIN NETWORKS

(71) Applicant: X Development LLC, Mountain View, CA (US)

(72) Inventors: Anikait Singh, Fremont, CA (US); David Andre, San Francisco, CA (US); Grace Taixi Brentano, Redwood City, CA (US); Karush Suri, Mountain View, CA (US); Lam Thanh Nguyen, Mountain View, CA (US); Salil Vijaykumar Pradhan, San Jose, CA (US); Gearoid Murphy, Mountain View, CA (US); Klara Kaleb, London (GB); Raja Dilip Panjwani, Philadelphia, PA (US); Sze Man Lee, Milpitas, CA (US); Ashish Jagmohan Chona, Saratoga, CA (US)

(21) Appl. No.: 18/589,228

(22) Filed: Feb. 27, 2024

Related U.S. Application Data
(60) Provisional application No. 63/448,629, filed on Feb. 27, 2023.
(60) Provisional application No. 63/487,237, filed on Feb. 27, 2023.
(60) Provisional application No. 63/448,635, filed on Feb. 27, 2023.

(51) Int. Cl. G06Q 10/0834; G06Q 10/067

(52) U.S. Cl. CPC G06Q 10/08345; G06Q 10/067

(57) ABSTRACT

Methods, systems, and apparatus, including computer programs encoded on computer storage media, for using a large language model as a common interface between entities in a supply chain network. One of the methods includes receiving, by a supply chain analysis system, a plurality of messages from entities in a supply chain network having a plurality of entities. Each message is provided to a large language model that is configured to generate modified messages that are in a standardized format, wherein the standardized format includes one or more data elements representing a proposed exchange in the supply chain network. The standardized messages are provided to one or more of the entities in the supply chain network to effectuate a communications interface through the large language model for entities in the supply chain network.

### CROSS-REFERENCE TO RELATED APPLICATIONS

This application claims priority under 35 U.S.C. § 119 to U.S. Provisional Patent Application No. 63/448,629, filed on Feb. 27, 2023, entitled “LARGE LANGUAGE MODEL INTERFACE FOR SUPPLY CHAIN NETWORKS,” U.S. Provisional Patent Application No. 63/487,237, filed on Feb. 27, 2023, entitled “LARGE LANGUAGE MODEL DERIVED ENVIRONMENT STATE CHANGES IN SUPPLY CHAIN LOGISTICS,” and U.S. Provisional Application No. 63/448,635, filed on Feb. 27, 2023, entitled “GENERATING NETWORK ALIGNMENT INFORMATION,” the entire contents of each of which are incorporated herein by reference.

### TECHNICAL FIELD

This disclosure generally relates to computer-implemented techniques for modeling and controlling supply chain networks.

### BACKGROUND

This specification relates to computer-implemented systems for enhancing the efficiency and performance of supply chain networks.

Supply chain networks are networks of entities that exchange information in order to reach a mutual agreement about the transportation of materials, goods, or other objects between locations. Often a supplier needs to transport materials to a downstream entity using one or more shipping entities that provide shipping services. For example, the supplier can supply raw materials to a factory for manufacturing, or the supplier can be a manufacturer supplying finished goods to a retailer.

Supply chain networks often face disruptions and major inefficiencies due to entities in the supply chain having imperfect information or imperfect decision making or decision-making policies. A major source of inefficiency occurs during the complex initial phase of any shipping contract in which a supplier must communicate with multiple shippers that have different goals, prices, and capabilities.

### SUMMARY

In one aspect, this specification describes a supply chain analysis platform that provides a common communications interface for entities in a supply chain using a large language model. Using the large language model to support a common interface between entities improves both the efficiency of negotiation processes, results in faster decision making at converge, and improves the efficiency of the resulting supply chain network.

In another aspect, this specification describes techniques for using large language models to augment and enhance computer-implemented techniques for controlling or simulating supply chain networks. The applications described in this specification relate to a computer-system that can automatically ingest supply chain data of a supply chain network for a variety of purposes. For example, the system can generate highly detailed simulations of the supply chain network. As another example, the system can use machine learning techniques, e.g., reinforcement learning, to generate action policies that are more efficient and more robust to disruptions than the information reflected in the input data.

In another aspect, this specification relates to techniques for generating network alignment information for a sequence of nodes in a supply chain. Given data representing variables representing properties of a sequence of nodes in a supply chain, the techniques can generate alignment information for the sequence of nodes in the supply chain. The alignment information can represent misaligned properties of the nodes in the sequence.

Using large language models can enhance the operation of the system in a number of ways described in more detail below. In this context, a large language model is a machine learned subsystem that uses one or more transformer layers that autoregressively transform an input sequence using self-attention. The transformer architecture is described in Vaswani et al., Attention Is All You Need, in the proceedings of the 31st Conference on Neural Information Processing Systems (2017). The large language models described in this specification can be implemented using encoders, decoders, or some combination of these. In this specification, an encoder is a language model having one or more transformer layers that takes an input sequence of tokens representing text and generates one or more output representations of the input sequence that can be used for a number of downstream tasks. In this specification, a decoder is a language model having one or more transformer layers that generates one or more output tokens for a sequence of input tokens. In practice, the inputs sequences are often learned word embeddings, e.g., vector representations to represent each word in an text input sequence.

In a first aspect, the techniques described in this specification relates to using large language models to derive environment state changes that affect supply chain networks. Large language models provide the ability to accurately query for the existence or non-existence of a contemporaneous phenomena from online sources, e.g., from online news sources. This allows the system to use information that is not represented in any particular database or in the input supply chain data. This information can be used for a variety of logistics applications, which can involve the coordination of storing and transporting objects within a supply chain. For example, trucks may be assigned to various geographically distributed locations so that all locations have some trucks available for transport.

However, emerging environment states may drive changes to logistics when emerging needs differ from the present configuration. For example, a natural disaster can disrupt a shipping port that has been traditionally used in a supply chain for the transport of goods. As another example, a labor strike can reduce throughput at a distribution center traditionally used by the supply chain. These emerging environment states are usually reported by various media outlets. In some cases, this reporting is made available over a world-wide network, for example, the internet.

A method can improve performance in supply chain logistics by quickly responding to changes in environment states. For example, by detecting a disruption in one shipping port, an alternative port can be recommended before the impact is felt in the supply chain. As another example, if the environment state indicates that a distribution center will be unavailable for an extended period of time, the system can recommend that alternative options be pursued. Providing these indications ahead of time can create greater certainty and visibility in logistics by quickly and efficiently identifying adverse conditions before they become impactful.

In order to efficiently and thoroughly analyze indicators of a change to an environment state, in some cases, the method can parse various forms of media reporting using a large language model. For example, the natural disaster affecting the shipping port could have been reported by a news article that was made available on the internet. In this case, the news article can be parsed by the large language model to derive an environment state where the shipping port is unavailable. Additionally, these large language models can be deployed with geographic and cultural context, allowing the models to determine further environment states driven by these factors.

In a second aspect, the techniques described in this specification include using large language models to enhance simulations of supply chain networks. Large language models can be used to generate realistic data that might not exist in the input data. This can include generating missing data retrieved or derived about real-world entities, e.g., the elevation of Denver, as well as generating plausible data for entities in the supply chain, e.g., a number of trucks in a shipping fleet, for example.

In a third aspect, the techniques described in this specification including using large language models to compress the action space of actions that need to be considered by agents making supply chain network decisions. This, for example, allows closely related actions to be represented by the same binned action. For example, ordering 10 medium blue shirts and 10 large blue shirts can be represented by a single binned action rather than two separate actions that need to be considered.

Particular embodiments of the subject matter described in this specification can be implemented so as to realize one or more of the following advantages. The techniques described in this specification drastically reduce the amount of time required for entities in a complex supply chain network to reach convergence or equilibrium on any proposed exchange of goods or services. The resulting arrangement of the supply chain network also has improved efficiency and is more robust to disruptions and catastrophic failures. In addition, the large language model can serve as an interface between hybrid bidding networks having both human and machine-learning agents as actors.

The techniques described in this specification also can allow users to quickly build and execute simulations on data that captures the effects of world states on supply chains, which can result in: a reduction in “idle time” of carrier or shipper assets, increased profitability, a lower carbon footprint realized through more effective shipping asset utilization, a reduction in warehouse or network backups, reduced road or supply network congestion, supply chain shortage prevention, risk reduction achieved through better market simulation, increased confidence in substantial or expensive business decisions, and an increased ability to respond to world events. Additional advantages of the first aspect of these techniques include the ability to incorporate highly accurate real-world data efficiently into simulation, increased supply chain simulation accuracy, and the ability to utilize a larger data pool, to include sources that are not otherwise formatted for direct inclusion in simulation. Additional advantages of the second aspect of these techniques include the ability to create more realistic simulations, especially when no immediate real-world data is available. Additional advantages of the third aspect of these techniques include reductions in processing requirements driven by more efficient simulation, increased decision making ability, and the ability to simulate the impacts of world events with respect to individual products or product lines.

Additionally, alignment information can provide a measure of how aligned a sequence of nodes in a supply chain is, and represent a velocity or efficiency of information transmission along the supply chain. In a supply chain that is not ideal, when an event that changes a value of a variable representing a property occurs at one node, the values of other relevant variables may not change immediately because information about the change is slow to travel along the sequence of nodes. In an ideal supply chain, changing a value of a variable representing a property results in immediate changes to the values of other relevant variables. Thus, a supply chain that is not ideal may be misaligned because its nodes and properties are not coordinated. By generating information representing one or more misaligned properties and computing a supply chain alignment index for a sequence of nodes, the techniques described in this specification can provide a measure of how aligned or misaligned the sequence of nodes is. Thus, the supply chain alignment index may provide a quantitative measure of deviation from perfect performance in an ideal supply chain. The techniques can provide insight into the efficiency of information transmission along a sequence of nodes, helping a user understand the supply chain.

Alignment information can also represent coordination of a supply chain. For example, in non-vertically integrated supply chains, a lack of coordination can lead to a competition penalty. The alignment information can measure a degree of the competition penalty.

The techniques can receive data representing variables representing properties of a sequence of nodes in a supply chain and generate alignment information based on the data. The data can be derived from real-world observations at nodes in the supply chain. Thus, the alignment information is relevant and based on what has occurred at real-world entities.

In addition, although the techniques generate alignment information using supply chain data derived from real-world observations, the techniques can also generate alignment information for simulations of the supply chain. For example, the simulations can simulate conditions that may not have been observed by entities in the data, such as adverse weather events. The techniques can generate modified data with new values for variables representing properties in a supply chain, and generate alignment information for the modified data. Thus, the simulation provides a more thorough understanding of the alignment of a supply chain by providing alignment information for situations that have not been observed yet by entities in the supply chain, but that have the potential to affect the supply chain.

Furthermore, the techniques can generate alignment information for the same supply chain at different points in time. Thus, the alignment information can provide insight into the historical performance of a particular supply chain.

The techniques can provide recommendations to a user that may improve alignment of a supply chain. The techniques can generate information representing one or more misaligned properties and use this information to identify which nodes in the supply chain are misaligned, for example. Thus, the techniques can provide recommendations such as structural changes, such as removing or replacing misaligned nodes, that may improve the alignment and performance of the supply chain when implemented. In addition, the techniques may suggest altering a decision-making policy for a user. For example, a user may avoid sending shipments to a certain node because it is misaligned.

The techniques can also provide a ranking of different variations of a supply chain that have different values for variables by each variation's associated alignment information and supply chain alignment index. This allows a user to determine which variation of a supply chain to implement for better alignment.

The techniques can also provide a ranking of different statistically independent misalignments of a supply chain based on the degree of their variability. This allows a user to determine which supply chain segment should be corrected for better alignment.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that illustrates an example supply chain network.

FIG. 2 is diagram of an example system having a supply chain analysis system that uses a large language model.

FIG. 3 is a flowchart of an example process for using a large language model as an interface for entities in a supply chain network.

FIG. 4 illustrates an example system for using a large language model to generate an environment state change.

FIG. 5 illustrates a flowchart of an example process for generating an action in a supply chain network using an agent and large language model.

FIG. 6 illustrates an example system for using a large language model to create and modify a supply chain simulation space.

FIG. 7 illustrates a flowchart of an example process for using a large language model to generate a supply chain simulation space.

FIG. 8 illustrates an example system for using a large language model to generate a binned action.

FIG. 9 illustrates a flowchart of an example process for using a large language model to generate a binned action.

FIG. 10 is a diagram of an example system for generating alignment information of nodes in a supply chain.

FIG. 11 illustrates a block diagram of an example sequence of nodes in a supply chain.

FIG. 12 is a flowchart of a process for generating alignment information of nodes in a supply chain.

Like reference numbers and designations in the various drawings indicate like elements.

### DETAILED DESCRIPTION

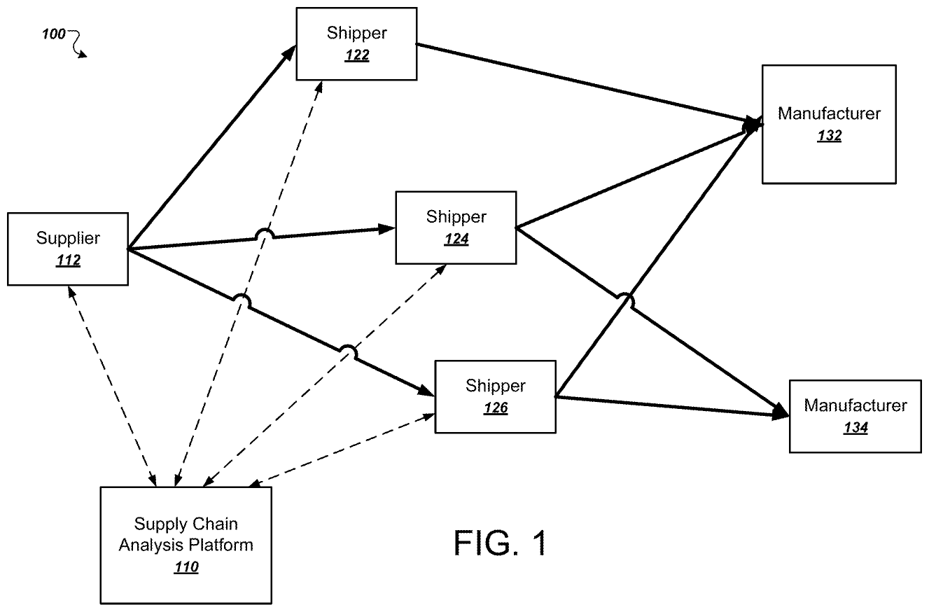

FIG. 1 is a diagram that illustrates an example supply chain network 100. The network 112 includes a number of entities having different roles, including a supplier 110, three shippers 122, 124, and 126, and two manufacturers 132 and 134. Each of these entities can be in communication with a supply chain analysis platform 110 that provides a common interface for the entities to communicate using a large language model.

In FIG. 1, the solid lines represent possible transport directions of goods in the network 100. Thus, the supplier 112 can ship goods to the first manufacturer 132 using either of the three shippers 122, 124, or 126. The supplier 112 can also ship goods to the second manufacturer 134 using either shipper 124 or 126. The first shipper 122 does not ship to the second manufacturer 134, which can be, for example, due to the locations in which the first shipper does not operate.

In FIG. 1, the dashed lines represent communications between entities and a supply chain analysis platform 110. The supply chain analysis platform 110 is a computer-implemented system that provides a common interface between entities in the network using a large language model. Thus, rather than the entities in the network communicating directly with one another, they communicate through the supply chain analysis platform 110.

The generalization capabilities of large language models allows the supply chain analysis platform 110 to provide a standardized experience for all the entities in the system. The state maintaining capabilities of large language models also allows the supply chain analysis platform 110 to provide summary information of the current state of the supply chain, the state of a negotiation, or other aspects of entities in the supply chain. For example, the state information can include current bids, history of past bids, and the best market bid, to name just a few examples.

In a typical scenario, the supplier 112 receives orders from the manufacturers 132 and 134 for goods or raw materials. The supplier 112 can then negotiate with the shippers 122, 124, and 126 to determine which shipper to select, as well as how much of the goods to ship, using each shipper in order to maximize the value of supplying the raw materials. This process traditionally includes many sources of inefficiency and can be slow to converge.

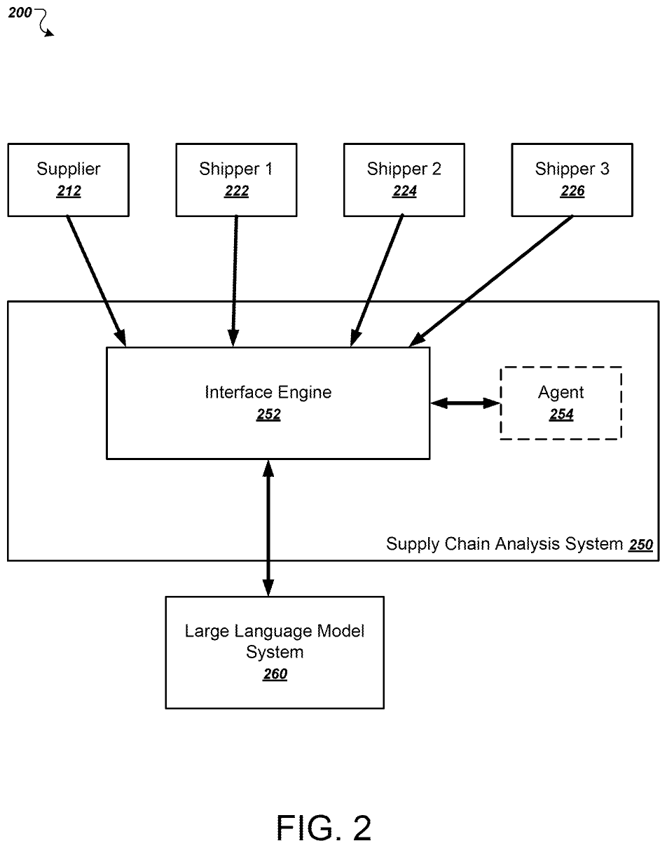

FIG. 2 is a diagram of an example system having a supply chain analysis system 250 that uses a large language model. In this example, the supply chain analysis system 250 serves as an efficiency-enhancing interface between a supplier 212 and three shippers 222, 224, and 226. The supply chain analysis system 250 uses a large language model system 260 on the backend of the interactions with the entities 212, 222, 224, and 226.

The large language model system 260 is a system of one or more computers in one or more locations that implements the operations of a transformer-based language model having one or more transformer layers. In some implementations, the large language model system 260 implements a decoder-only model that takes natural language inputs from the entities 212, 222, 224, 226, and converts them into a standard format. In some implementations, the standard format is a raw text output decoded from learned embeddings. The large language model system 260 is illustrated as being a separate computer system than the supply chain analysis system 250, but alternatively the two systems can be integrated into one distributed computer system.

An example of the supplier 212 using the supply chain analysis system 250 as an interface between the shippers 222, 224, and 226 will now be described. The messages described below would all be routed through the supply chain analysis system 250 and converted by the large language model system 260. For brevity, not all interactions of these systems are recited. Thus, for example, if a message is described as being sent from the supplier 212 to a shipper 222, this is to be understood as actually being routed through the supply chain analysis system 250 and acted upon by the large language model system 260 rather than being sent directly between the entities.

At time 1, the supplier 212 can provide a notification to the supply chain analysis system 250 that it has received one or more orders from downstream entities in the supply chain. The notification can indicate a quantity and a location for a particular type of goods.

For example, the initial notification can be natural language text that states:

“I have received orders to ship 3000 board feet of lumber to Ace Manufacturer and to ship 5000 board feet of lumber to Best Manufacturer.”

The supply chain analysis system 250 can interpret this notification as a prompt to gather bids from the shippers.

The supply chain analysis system 250 can provide the initial notification to the large language model system 260 and receive back a standardized format message that distills the information down into a concise form of an shipping request message:
“Possible lumber shipping opportunities.
3000 BF to Ace Manufacturer.
5000 BF to Best Manufacturer.”

The supply chain analysis system 250 can provide the shipping request message to computer systems installed at each of the shippers 222, 224, and 226. The shippers can provide a natural language response back to the supply chain analysis system 250 indicating a proposed quantity and a price.

The supply chain analysis system 250 can then feed the different natural language responses through the large language model system 260 to generate standardized bid messages, which are then provided back to the supplier 212.

For example, the first shipper 212 can provide the following natural language response:
“I can handle 2000 BF to Ace Manufacturer for $500, but I don't ship to Best Manufacturer.”

The second shipper 224 can provide the following natural language response:
“My capacity is limited right now, but I could ship 500 BF to Ace Manufacturer for $200 and 200 BF to Best Manufacturer for $90.”

The third shipper 226 can provide the following natural language response:
“I can ship all 5000 BF to Best Manufacturer for $1000.”

The large language model can then generate standardized bid messages, for example, having the following content.

Bid message 1:
“Sender: Shipper 1
Ace Manufacturer: 500 at $0.25 per BF.
Best Manufacturer: None.”

Bid message 2:
“Sender: Shipper 2
Ace Manufacturer: 500 at $0.40 per BF.
Best Manufacturer: 200 at $0.45 per BF.”

Bid message 3:
“Sender: Shipper 3
Ace Manufacturer: 5000 BF at $0.20 per BF.
Best Manufacturer: None.”

The supplier 212 can receive these standardized bid messages and can very easily determine how to allocate shipping resources in order to maximize the value of providing the goods. Notably, the generalization capabilities of the large language model allowed it to concisely summarize the relevant information and perform the arithmetic needed to present the price in standard units, e.g., dollars per board foot shipped.

The supplier 212 can then provide a counter-offer message to the supply chain analysis system 250. For example, the counter-offer message could say:
“Shipper 1, would you accept $0.22 per BF?”

The supply chain analysis system 205 can then provide the counter-offer message to the large language model system 260, which can transform the counter-offer message into a standardized format:
“Recipient: Shipper 1
Quantity: 500 BF
Price: $0.22 per BF.”

Notably, the counter-offer message includes the identity of a recipient, which the supply chain analysis platform 250 can use to route the message to the identified shipper rather than all of the shippers.

The shipper 222 can provide a similar counter-offer message in response:
“The best I can do is 24 cents.”

One of the advantages of decoder-only large language models is their ability to maintain state during the course of an interaction. Thus, the model pays attention to recent interactions in order to compute the probabilities associated with each output term. The model can utilize the self-attention mechanism to store past interactions in the form of learned embeddings.

In this example, due to the context of the conversion, the model can determine that 24 cents is associated with the recent interaction between the supplier 212 and the shipper 212. In response, the large language model system 260 can automatically generate a more complete counter-offer message for the shipper:
“Sender: Shipper 1
Ace Manufacturer: 500 at $0.24 per BF.
Best Manufacturer: None.”

Notably, the large language model is able to fill in missing pieces from the context of the conversation. The supplier can then provide a natural language acceptance message:
“Offer accepted.”

The large language model system 260 can in response generate a final bid acceptance message for the shipper 222:
“Recipient: Shipper 1
Accepted Bid.
Quantity: 500 BF.
Price: $0.24 per BF.”

As this example illustrates, the supply chain analysis system 250 provides an intuitive and efficient means for exchanging information between supply chain entities. The large language model system 260 serves not only to standardize the messages, but also to automatically provide appropriate context when needed.

As demonstrated by this example, the use of a large language model in and of itself can greatly improve the efficiency of negotiation process. The supply chain analysis system 250 can optionally also use a machine-learned agent 254 to introduce further efficiencies in the supply chain.

The agent 254 is a computer-implemented machine-learning system that has been trained to take or recommend actions for a particular input scenario. For example, the agent 254 can be a system trained using reinforcement learning to implement an action policy for particular input data. Rather than acting as only a communications interface between the entities in the supply chain, the agent 254 can actually steer the conversation toward a more optimal solution while also ensuring that all entities are reaching mutually beneficial arrangements. In general, a solution for any party is only viable if it is also viable for another party. Thus, the agent 254 can steer the entities toward mutual collaboration rather than competition that is inefficient for the network as a whole.

In some implementations, the agent 254 uses as input data detailed information about the state of the supply chain network and the entities participating in the network. For example, the agent 254 can consider many other types of data that are external to the messages exchanged between the entities, such as current weather patterns or other local or wide scale disruptions to the network. In some cases, the agent 254 may have access to capacity data for entities in the network, such as current capacity levels for the shippers to transport goods or the supplier to supply them. The entities can provide this information voluntarily to the supply chain analysis platform 250 or it can be derived from other sources.

The agent 254 can be used to enhance the message exchanging process in a variety of ways. In general, the agent 254 will analyze a state of the supply chain network to make a recommended action. The recommended action can be based on a reinforcement learning policy that is learned over real-world data or in simulation. For example, a vast collection of supply chain network scenarios and their outcomes can be generated synthetically and then used to train the agent 254 in simulation. Therefore, the agent 254 can be well-equipped to make decisions in the face of phenomena that have not been observed or encountered in historical data.

The recommended action can be used in the message exchanging process in a variety of ways.

As a first example, the agent can generate a recommended action for each entity. For example, when the supply chain analysis system 250 provides a message to one of the shippers regarding an ongoing negotiation with a supplier, the agent 254 can insert a recommendation. In the example above, the agent can insert a recommendation into the original message:
“Recipient: Shipper 1
Quantity: 500 BF
Price: $0.22 per BF.”
Recommendation: Bid $0.24.”

The “Recommendation” line can represent a price that the agent's policy has determined to be a price likely to be accepted by the supplier. The shipper 222 can then decide to make an offer using the agent's recommendation.

In this way, the use of the agent 254 can cause the process to converge drastically faster than without recommendations. This is even more so the case when the entities are aware that an intelligent machine-learned agent 254 is making recommendations because they trust that the agent 254 favors supply chain efficiency and mutual benefit rather than any particular entity in the supply chain.

Agent recommendations can also greatly improve the efficiency of the supply chain itself. For example, suppose that shipper 1 bids the lowest shipping cost among the three shippers. A naive decision-making policy might make supplier 212 choose the first shipper 222 to supply 100% of the materials to the manufacturer.

However, supply chains have many other complicated aspects other than price. For example, the agent 254 might have supply chain state information indicating that the first shipper 222 is running at 90% capacity due to other customers that will cause massive delays in getting the materials to the manufacturer.

Therefore, when the agent 254 receives the initial bids from the shippers 222, 224, and 226, the agent 254 can use its trained action policy to make a recommendation to the supplier about which shippers to choose. For example, the agent 254 can recommend that the supplier 212 use at least one other shipper, even if it costs more, due to the fact that the large delays would more than offset slightly higher shipping costs.

The supplier 212 would receive the recommended course of action in a concise, easy-to-read and standardized format generated by the large language model 260, from which the supplier 212 can make the easy decision to follow the agent's 254 recommendation. In this way, the negotiation process converges immediately after the first round of bids, and in a way that improves not just the efficiency of the negotiation process but the efficiency of the resulting supply chain arrangement as well.

Another example use case for using the agent's action policy is in making bids on behalf of entities in the supply chain. The bids can either be blind or named. With a blind bid, the receiving entity does not know that the bid was actually generated by an agent, whereas with a named bid, the receiving entity will get an indication that the bid is being made by the agent on behalf of another entity and the type of the other entity.

For example, when the initial message was sent from the supplier to the shippers, the agent could on the very first pass make a bid on behalf of the first shipper 222. In doing so, the agent might initially propose $0.24 per board foot due to learning an action policy through many simulations that the supplier 212 does not accept over that amount. Therefore, the entire counter-negotiating process can be skipped over and the process converges efficiently.

A last variation of using agent recommendations is to install entity-specific agents at one or more entities in the network. The agents, using their machine-learned action policies, can collaborate to quickly reach equilibrium in the negotiation process.

Moreover, by using the large language model system 260 as an intermediary between the entities in the negotiation process, the supply chain analysis system 250 can serve as an interface between any arbitrary mix of agents and human actors. For example, two of the shippers 222 and 224 might have agents installed on their ordering systems, which communicate with a human reviewing at the supplier 212 through the standardized messages generated by the large language model system 260.

In this way, using the large language model system 260 as an interface in the negotiation process serves to improve the efficiency in any arrangement of entities in the network, be it all humans, all agents, or some mix of humans and machine-learned agents.

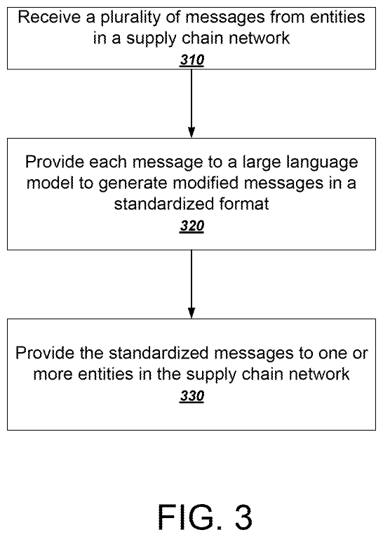

FIG. 3 is a flowchart of an example process for using a large language model as an interface for entities in a supply chain network. The example process can be performed by a computer system of one or more computers in one or more locations and programmed in accordance with this specification, e.g., the supply chain analysis system 250 of FIG. 2. For convenience, the process will be described as being performed by a system of one or more computers.

The system receives a plurality of messages from entities in a supply chain network having a plurality of entities (310). The messages can pertain to any appropriate goods or services to be negotiated and agreed upon in the supply chain network.

The system provides each message to a large language model to generate modified messages that are in a standardized format (320). As described above, the standardized format can include one or more data elements representing a proposed exchange in the supply chain network, e.g., a price per unit, a number of units, or a recipient. For example, the data elements can represent a quantity of goods to be shipped or a unit price for shipping the goods or a quantity of raw materials requested by a factory or a unit price for purchasing the raw materials.

In some implementations, the system can use a machine-learned agent to provide recommended actions along with the standardized messages in order to speed the convergence of the negotiation process. For example, the system can add recommendations by the agent to the standardized messages sent to entities in the system. The system can also make proposals to one or more entities in the system on behalf of other entities in the system.

The system provides the standardized messages to one or more of the entities in the supply chain network (330). The system can continue serving as an interface between the entities until the negotiation converges. In this way, the system essentially effectuates a communications interface through the large language model for entities in the supply chain network.

In addition to the uses described above, the language model embeddings can be used for other downstream tasks as well. For example, learned parameters could be utilized to generate synthetic bidding datasets for training other LLM models. Similarly, the model can also be used to predict future prices and reason about market trends/variations.

The interface can be built by pre-training or fine tuning an LLM for conversational dialogue. In the case of pre-training, the model is trained on a large corpus of past historical samples and gradually shifted to the deployment phase. In the case of fine tuning, the model can be transferred directly to the deployment phase and additionally trained on new real-world samples.

In another aspect, the methods as discussed in this specification can use large language models to predict environment states for simulating and making decisions in supply chain networks. These techniques can be implemented in a computing system having one or more computers in one or more locations that parses online content to derive environment state changes that can impact supply chain logistics. In some implementations, these environment states can be used by the system to inform supply chain action policies, trial different simulation scenarios to determine an optimal solution, and recommend binned, or compressed, actions.

In general, environment state changes that can be discovered by an LLM querying recent sources include contemporaneous events that can affect supply chain networks, e.g., civil, geopolitical, or weather-based events. An example of a civil environment state change could be a major labor strike occurring at a distribution center in, or adjacent to, the supply chain network. Another example of a civil environment state change could be increased traffic due to a road closure or other major event. An example of a geopolitical environment state change could be new legislation passed in a foreign country that imposes restrictions on the supply chain. Another example of a geopolitical environment state change could be a substantial deterioration of relations between two countries within the supply chain network. An example of a weather environment state change could be a tsunami that disrupted operations at a port utilized by the supply chain network. Another example of a weather environment state change could be a major hurricane that is expected to pass through an area where the supply chain network operates.

An LLM can be configured generate environment state changes that possess one or more elements that describe a characteristic of the environment state change. For example, an element of a “strike” environmental state change can be the percentage of the facility that is automated. In this scenario, the element can be an indication that fifty percent of the facility is automated. Another example of an element in this scenario could be a distance of the facility experiencing the strike to the next facility in the supply chain network, or the distance to the closest facility in the supply chain network if the strike occurs outside of the network. Examples of elements in a “hurricane” environmental state chain can be a designation of the hurricane's category, or its expected “storm surge” height. Examples of elements in a geopolitical environment state change can be a time before legislation takes effect, or a severity of a particular geopolitical event. In general, elements can be any discernable metric or characteristic associated with an environment state change.

The system can also model one or more features of the supply chain network that are impacted by environment state changes. For example, a feature could be a shipping port, distribution center, factory, or a shipping route or lane. Another example of a feature could be a truck, ship, or aircraft utilized by the supply chain network. Further examples of features can include a shipping time associated with a route, an inventory level at a facility, a “critical path” associated with a particular item, an estimated delivery time, or a demand level. Similar to elements, features can be any discernable metric or characteristic associated with a supply chain network.

The LLM can generate the environment state changes by querying various forms of online media. Examples of this media include new websites, blogs, social media platforms, and applications. This reporting usually contains relevant information and elements relating to environment state changes. For example, a local news outlet can report on an approaching hurricane and indicate that the hurricane is expected to be a “category 4” at landfall in approximately four hours, and that the expected storm surge will be approximately ten feet. Another example of media reporting could be an article that describes the passing of a new law in a country that restricts the usage of trucks weighing over six tons along a particular road. Media reporting can also encompass any of the additional environment state changes described above, and more. In some implementations, media include publicly available media. For example, the reporting on the hurricane described above can be published on the local news station's public website on the internet. As another example, a blog hosted on a public web server can document the changes in truck restrictions in the foreign country. Alternatively, the new trucking legislation could have been publicly announced, and made available on the corresponding governmental website. Like elements and features, media can take various forms and can include any discernable account or description from which environment state changes, elements, or features can be extracted.

A large language model can process the online media to generate information representing environment state changes in a number of ways. An example could be an encoder-only large language model that generates representations of an impact to a supply chain feature based on an adverse element extracted from a media account of an environmental state change. For example, an encoder large language model can be used to generate an output representing an environment state change that can be used by the reinforcement learning agent to determine if the environment state change is occurring, and in response, adjust the supply chain simulation accordingly. One example could be an encoder large language model parsing a set of media documents and assigning the data contained in the media documents to a representation that models the impacts of a hurricane, such that the reinforcement learning agent can apply a hurricane environment state change to any decision-making policy or simulation.

Another example use of a large language model could be a decoder-only model that extracts text from media that is known to correlate to an element or feature. For example, when parsing media documents, a decoder large language model can determine that a hurricane environment state change is occurring based on the extracted text. In other examples, the decoder large language model can be trained to decode other environment state changes of interest, for example, any of the civil, geopolitical, or weather environment state changes described above. The decoder large language model can also be trained to analyze text with respect to supply chain features, for example, shipping ports, facilities, or resources used by the supply chain. Additional uses of large language models will be described below.

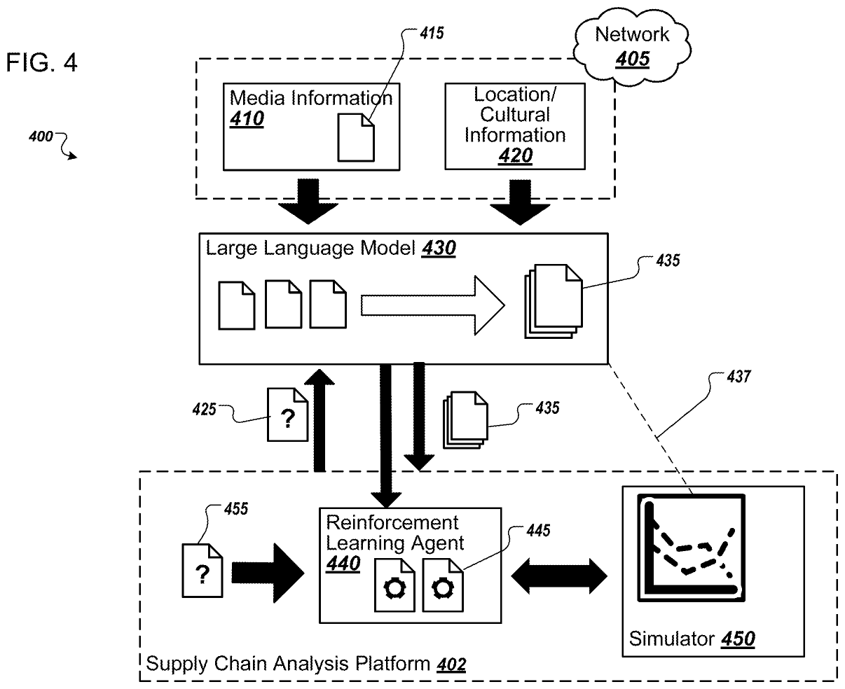

FIG. 4 illustrates an example system 400 in which the techniques described in this specification can be implemented. The system includes a supply chain analysis platform 402 in communication with large language model system 430. The supply chain analysis platform 402 includes a reinforcement learning agent 440 and a supply chain simulator 450. Each of these components can be implemented by a system of one or more computers in one or more locations and programmed in accordance with this specification.

The supply chain analysis platform 402 is a computer system that provides various tools for making decisions in and simulating the effects of supply chain networks. As one example, the supply chain analysis platform 402 can train the reinforcement learning agent 440 to learn more efficient supply chain policies when provided with input supply chain network data. The simulator 450 can be used to run hundreds or thousands of simulations of various supply chain network scenarios with or without the decision-making actions of the reinforcement learning agent 440.

The supply chain analysis platform 402 can enhance its view of a real-world supply chains by leveraging the power of the large language model system 430. The large language model system 430 is a computer system that can provide an interface to a large language model. The large language model implemented by the large language model system 430 can be any appropriate autoregressive language model having one or more transformer layers.

In order to update the environment status of a supply chain for the supply chain analysis platform 402, the supply chain analysis platform can provide a request 425 to the large language model system 430. The request 425 can be a request to generate an updated representation of an environment state. This request 425 can include a prompt to examine a particular environment state change 445 that is occurring, or that has occurred. For example, a hurricane (a “weather” environment state change) could be approaching an area where the supply chain operates, a strike could have occurred at a nearby distribution center (a “civil” environment state change), or a new law affecting shipping could have been passed in a country where the supply chain operates (a “geopolitical” environment state change). In these examples, the large language model 430 can be requested 425 to examine these environment state changes 445 with respect to one or more features modeled in the supply chain simulator 450. For example, the large language model 430 can be requested 425 to examine the anticipated impact of the approaching hurricane on shipping ports, the likelihood a strike at a neighboring facility will spread to facilities operating in the supply chain, or the effect of a new shipping law on the large trucks operating in the supply chain. The request 425 can also optionally include a description of an environment state change 445 and/or features present in the existing simulations created by supply chain simulator 450.

Alternatively or in addition, the reinforcement learning agent 440 can use the environment state data 445 as input to generate actions to be taken in a real-world supply chain network or in a supply chain simulation being performed by the supply chain simulator 450. For example, when requesting the reinforcement learning agent 440 to produce actions for an updated simulation for the “large trucks” feature of the supply chain, the system 402 can query the large language model 430 for any detected environment state changes 445 that are known to impact that feature (e.g., a new shipping law, or a natural disaster affecting the routes utilized by the large trucks).

The request 455 can also include a request to perform an action in the supply chain network. This action can include a variation of a supply chain feature, or a recommended addition or subtraction of a feature. For example, the action referenced in request 455 can include instructions for the reinforcement learning agent 440 to propose a shipping port that will not be impacted by the approaching hurricane. Another example action could include requesting 455 the reinforcement learning agent 440 to recommend an appropriate supply chain feature (e.g., a suitable truck or shipping method) that is compliant with new legislation. These actions can be recommendations in simulation, or actual changes in supply chain operation that the reinforcement learning agent 440 can effectuate over a network. For example, a reinforcement learning agent 440 can be requested to perform an action to evaluate changing shipping ports in response to a hurricane. Another example of an action could be using a reinforcement learning agent 440 to recommend or initiate a change in production of a certain product in response to a global event.

In some implementations, initial training can be conducted with large language model 430 with various forms of information 410 and 420. This initial training can include knowledge 437 of the existing supply chain simulation created by supply chain simulator 450, a query of terms that should be extracted from media documents 415, a relation between an element of an environment state change to a feature of the supply chain network, an initialization of a current environment state, or a combination of any of these relations.

In response to request 425 or 455, the large language model 430 can retrieve various forms of media information 410 and cultural/location information 420 for fine-tuning the initial training, or just simply for decoding the information. This information can include media documents 415 obtained over network 405. An example media document could be an article, blog, webpage, or other written account where contextual information can be extracted. One example where the large language model 430 can retrieve a media document 415 can be obtaining a transcript of a webpage publicly available on the internet. In another example, the large language model 430 could retrieve a press release published to a government organization's website that discusses a new law or ordinance.

Additional location and cultural data 420 can also accompany the media information 410. For example, in addition to the elements contained within the media information 410, the geographic location of the event described in the media information 410 can be determined. Additionally, cultural context can also be provided where this information is relevant. For example, if a feature of a supply chain network is an inventory of clothing, the method can determine if this clothing would be culturally inappropriate or offensive in the geographic region of interest.

Media documents 415, once retrieved, can be parsed by the large language model 430 to extract relevant elements. For example, a webpage media document 415 can be parsed to extract elements related to an approaching hurricane. In this case, the extracted elements can be the anticipated hurricane path, the severity of the storm, and an estimated impact to the community.

Once extracted, the elements can then be aggregated 435 by the large language model 430. For example, the large language model 430 can parse various media documents 415 and combine similar elements into a single aggregated elements 435. One example could be parsing five similar media documents 415 describing the path of an approaching hurricane and aggregating the predictions such that the most likely path is determined. The resulting element can then be preserved as an aggregated element 435. Other examples of aggregation could be an additive process, in which the total scope of an element is captured by multiple media documents 415. For example, multiple local media documents 415 may each report the impact of a new law that restricts the movement of heavy trucks on public roads. In this example, the large language model 430 can aggregate each of the elements into an aggregated element 435 that completely captures the effect of the new law on the supply chain network. Additionally, the large language model 430 can use the aggregated elements 435 to generate a textual description that describes the impact or effects of the environment state change 445.

Aggregated elements 435 can then be used by the supply chain analysis platform 402 to determine that an environment state change 445 has occurred. For example, once the aggregation process is complete, the supply chain analysis platform 402 can determine that there is a very high probability that the shipping port used by the supply chain network will be made unavailable by the approaching hurricane. As another example, the supply chain analysis platform 402 can also determine that a shipping route used by the supply chain network is in the path of the hurricane, and as a result, trucks using that route will experience substantial delays. To correlate aggregated elements 435 to features in the supply chain network, the large language model 430 can be given knowledge 437 of the current supply chain network or supply chain network simulation created by supply chain simulator 450. Once the supply chain analysis platform 402 determines that an impact to a supply chain network feature is likely, this information is passed to the reinforcement learning agent 440 with the environment state change 445.

Once an environment state change 445 has been determined, it can then be passed to one or more reinforcement learning agents 440 that can use the information to alter the operation of one or more supply chain simulators 450. In some implementations, the reinforcement learning agents 440 can use the environment state change 445 as additional constraints on the supply chain network that must be satisfied. Alternatively or additionally, the environment state change 445 can cause the reinforcement learning agent 440 to propose an action to alter one or more features of the supply chain network. For example, upon receiving an environment state change 445 from the large language model 430 that indicates a strike at a particular distribution center, the reinforcement learning agent 440 can determine an optimal supply chain that bypasses the distribution center. As another example, an environment state change 445 that indicates a new law restricting heavy trucks on public roads can cause the reinforcement learning agent 440 to propose solutions to supply chain simulator 450 that utilize smaller trucks that are compliant with the new law. As yet another example, the reinforcement learning agent 440 can cause supply chain simulator 450 to simulate the unavailability of a shipping port for a specified period of time following the reception of a hurricane environment state change 445. In some implementations, the reinforcement learning agent 440 can effectuate one or more of its recommended actions.

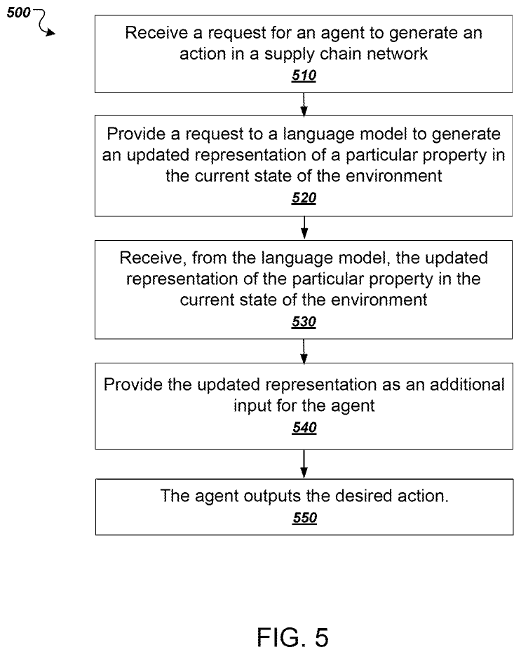

FIG. 5 illustrates a flowchart of an example process 500 for generating an action in a supply chain network using an agent and large language model.

The process 500 includes receiving a request for an agent to generate an action in a supply chain network 510. This action can be a request for an updated supply chain simulation, or for the agent to perform an action to change the operation of a feature of the supply chain network.

The process 500 includes providing a request to a language model to generate an updated representation of a particular property in the current state of the environment 520. This request can cause a large language model to retrieve information from media documents available over a network, for example, the internet. This information can be supplemented with location and cultural information that allows the large language model to add context to the media information. The large language model can then parse this information to determine a particular property in the environment, for example, an environment state change.

The process 500 includes receiving, from the language model, the updated representation of the particular property in the current state of the environment 530. This updated representation can be a change in the environment driven by an environment state change, for example, a geopolitical or weather event.

The process 500 includes providing the updated representation as an additional input for the agent 540. The updated representation can cause the reinforcement learning agent to propose or effectuate changes to features of the supply chain network.

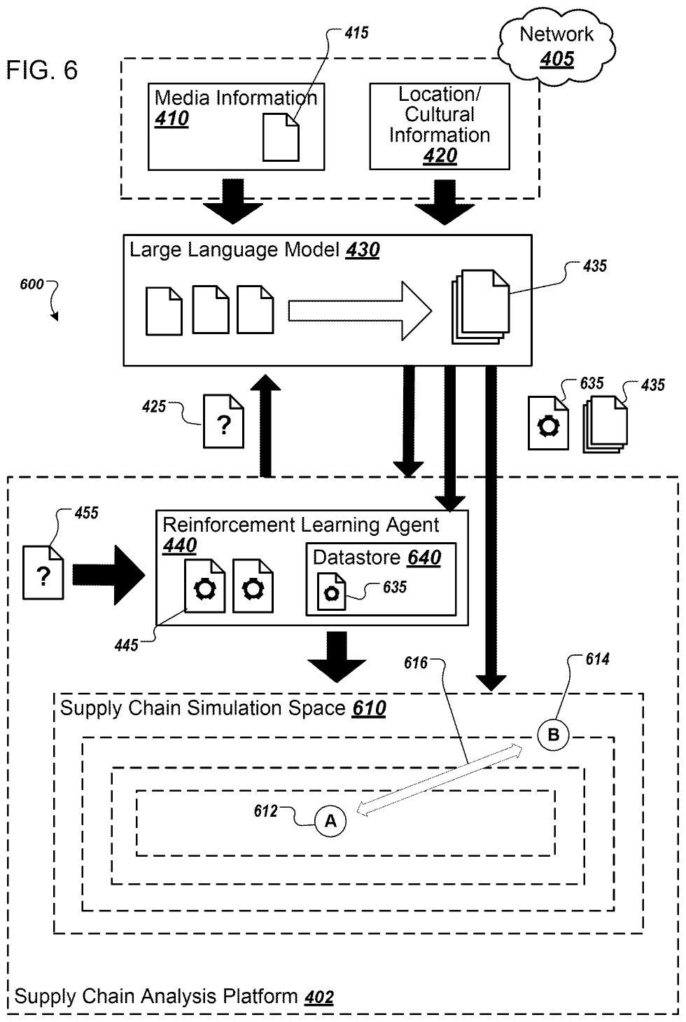

FIG. 6 illustrates an example system 600 in which the methods of this specification can be implemented. The system 600 includes all of the components of system 400, while additionally including a supply chain simulation space 610.

In some implementations, the operation of system 600 is similar to system 400 in that aggregated elements 435 are generated by the large language model system 430 and passed to the supply chain analysis platform 402. In addition to producing multiple supply chain simulations using supply chain simulator 450, as shown in FIG. 4, the system 600 can produce a supply chain simulation space 610 that allows features of the supply chain network, and elements of any environment state changes 445, either real or simulated, to be varied.

The system 600 can also generate additional simulation scenarios for fictional environment state changes 445 to train the reinforcement learning agent 440 in simulation. For example, using previous training, the large language model 430 can create simulation scenarios 635 for a supply chain simulation space 610 in supply chain analysis platform 402 that includes an environment state change 445 that has not yet occurred. One example could be using the large language model 430 to generate a representation of an earthquake in the supply chain analysis platform 402 to train the reinforcement learning agent 440 on an appropriate response. In this example, initial training with the large language model could include parsing information 410 and 420 from past events to associate environment state change 445 elements to supply chain features, generating simulation scenarios 635 using these relationships, and then providing these simulation scenarios 635 to the supply chain analysis platform 402 to simulate the theoretical impact of the fictional earthquake on the existing supply chain network in supply chain simulation space 610. For example, the large language model 430 can extract elements from a past earthquake (e.g., a magnitude or destructive power) and apply them to existing supply chain features (e.g., a distribution center or factory) to determine which features would likely be affected should a similar earthquake occur. In this way, the supply chain analysis platform 402, the supply chain simulation space 610, and the supply chain network, can be configured to respond efficiently and effectively to these rare events, even if they were never represented previously.

To generate simulation scenarios 635 for a fictional environment state change 445, large language model 430 can create plausible simulation data for elements of the environment state change 445, features of the supply chain network, or both. For example, while some data can be definitively obtained by the large language model 430 for the purpose of creating a simulation scenario 635 (e.g., the distance of a factory to the coastline, or an elevation of a facility), some data may only be able to be approximated (e.g., the number of trucks on the road when a natural disaster strikes a distribution center). To solve this issue, the large language model 430 can create a reasonable approximation of this data, such that a complete simulation scenario 635 can be passed to the supply chain analysis platform 402. For example, when simulating a hurricane that floods a distribution center, the large language model 430 can create simulation data that reflects that seventy percent of the trucks that utilize the distribution center were on the road at the time of the disaster. By creating these data points in the simulation scenario 635, the large language model 430 can allow the supply chain analysis platform 402 and reinforcement learning agent 440 to train on a realistic simulation scenario 635, provided that the created data is representative of average or expected values.

In some implementations, the supply simulation space 610 includes many different supply chain simulations scenarios 635, for example, scenarios “A” 612 and “B” 614. While only two scenarios are shown in the supply chain simulation space 610, in actuality there can be many scenarios (e.g., hundreds or thousands). These scenarios 612 and 614 can each vary 616 one or more elements of the environment state change 445. Varying elements of the environment state change 445 can be beneficial when the complete impact of an environment state change 445 is unknown, or will be difficult to model.

For example, it can be beneficial to model a hurricane environment state change 445 in supply chain simulation space 610 if the path or impact of the hurricane can only be approximated by media documents 415. In this case, scenario “A” 612 can represent a conservative prediction of the severity of the hurricane while scenario “B” 614 can represent a more unlikely scenario where the hurricane is more severe. Additionally, because some environment state changes 445 are rare (e.g., earthquakes), simulating these scenarios in supply chain simulation space 610 allows reinforcement learning agent 440 to train on various actions and responses even when no actual event data may be available. These simulations can include simulation scenarios for a minor event with a limited impact, or a more severe event with a substantial impact. In this way, the reinforcement learning agent 440 can propose solutions that react to both environment state changes 445 that are likely, and those that are unlikely (but still possible).

Another example of a variation 616 in supply chain simulation scenarios can be simulating a loss of power to a factory as an environment state change 445, where the variation 616 is the time required for power restoration. In this example, scenario “A” 612 can predict a timely restoration of power, while scenario “B” 614 predicts a more delayed restoration. For both scenarios, the reinforcement learning agent 440 can recommend different actions to the supply chain network, or alterations to features present within the supply chain network. In some implementations, the reinforcement learning agent 440 can be trained on the variation 616 between scenarios “A” 612 and “B” 614, to include the different actions and features that are altered as the scenario changes.

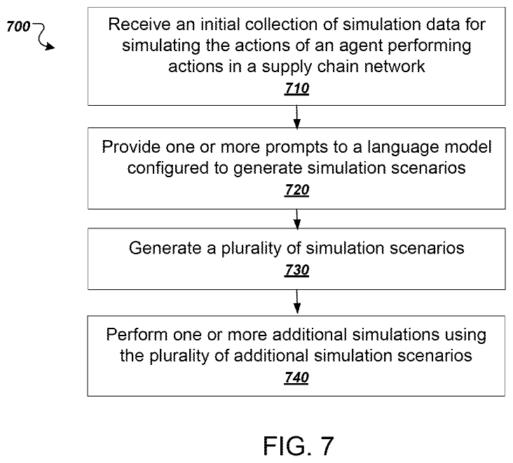

FIG. 7 illustrates a flowchart of an example process 700 for using a large language model to generate a supply chain simulation space.

In some implementations, the process 700 includes receiving an initial collection of simulation data for simulating the actions of an agent performing actions in a supply chain network 710.

The process 700 includes providing one or more prompts to a language model configured to generate simulation scenarios 720. These prompts can include a change in the environment of the supply chain network, for example, an environment state change. This prompt can be provided directly to the large language model, or the prompt can be extracted from documents obtained over a network.

The process 700 includes generating a plurality of simulation scenarios 730. These simulation scenarios can vary an element of the prompt, for example, an element of the environment state change. This variation can be a severity, a location, or an impact of the environment state change.

The process 700 includes performing one or more additional simulations using the plurality of additional simulation scenarios 740. These additional simulations can be used to adjust the actions taken by the agent in response to the prompt, for example, the environment state change. Each additional simulation can vary the actions of the agent to account for the corresponding variation of the prompt.

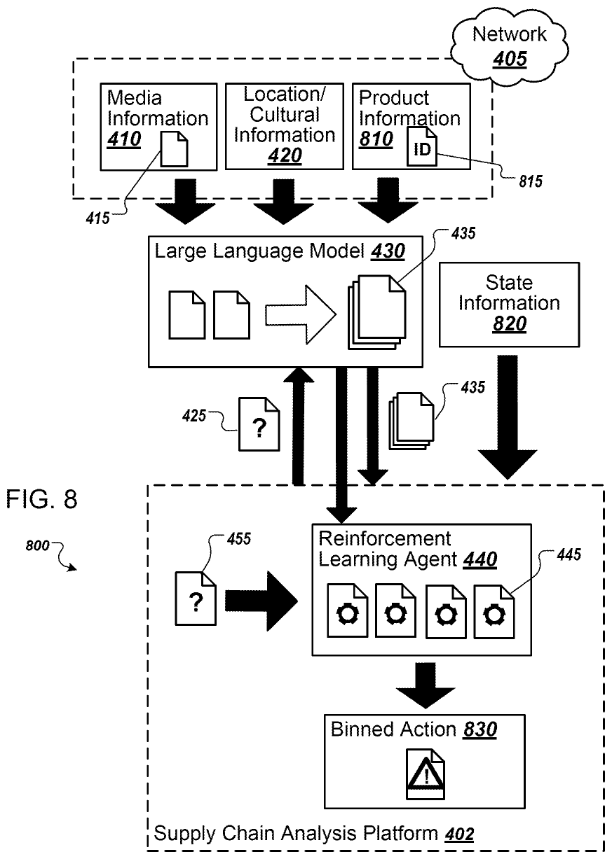

FIG. 8 illustrates an example system 800 in which the methods of this specification can be implemented. The system 800 includes all of the components of system 400 and 600, while additionally including product information 810, state information 820 and a plurality of binned actions 830.

In some implementations, the operation of system 800 is similar to system 400 and 600 in that aggregated elements 435 are generated by the large language model system 430 and passed to the supply chain analysis platform 402. In addition to producing multiple supply chain simulations using supply chain simulator 450, as shown in FIG. 4, and a supply chain simulation space, as shown in FIG. 6, the system 800 can recommend binned actions 830 in response to receiving product information 810. For example, a binned action 830 could include ordering a certain amount of a product, the instructions to manufacture a certain product, or a prioritization of the delivery of a certain product. Additional examples of binned actions 830 are discussed below.

Product information 810 can include a plurality of product descriptions 815. Product descriptions 815 can include an identifier and a collection of text that describes a product. For example, a product description can be a “red shirt” identifier with an accompanying description that describes the “red shirt” as a clothing item. While only one product description is shown in the figure, it should be understood that there can be many product descriptions 815 provided as part of product information 810 to the large language model 430 (e.g., hundreds or thousands). Additionally, product descriptions 815 can be created for any item that can be distinguished from another. Further examples of product descriptions could be a “television,” a “blue shirt,” or even a “large red shirt” (as opposed to a “small red shirt”).

Large language model 430 can parse this product information 810 to perform different actions, for example, using an encoder large language model that generates language embeddings of product descriptions 815, such that they can be associated to other product descriptions 815, media documents 415, environment state changes 445, or supply chain features. Another example use of a large language model could be a decoder model that extracts text from product descriptions 815 that is known to correlate to an element or feature.

Language embeddings generated by the large language model 430 can be passed to the supply chain analysis platform 402 and used to simplify the generation of actions by the reinforcement learning agent 440. For example, in a supply chain network with a large amount of products (e.g., 30,000), a reinforcement learning agent 440 may have significant difficulty in generating actions for a supply chain simulation that captures the impact of an environmental state change 445 to every product. One benefit of generating language embeddings in product descriptions 815 is that these language embeddings can be used to associate similar products or product types. Using this method, the reinforcement learning agent 440 can associate similar products or product types with others, effectively reducing the total number of products that must be evaluated in simulation (e.g., reducing the 30,000 products to only a few hundred aggregated product types). One additional benefit of using language embeddings is that it simplifies the process of adding new products to existing simulations as these new products can be associated with previously generated language embeddings.

Once the product information 810 has been parsed by the large language model 430, the resulting language embeddings or extracted text can be passed to the supply chain analysis platform 402 and reinforcement learning agent 440 for use in recommending different actions in the supply chain network. Examples of actions that can be recommended by the supply chain analysis platform 402 and reinforcement learning agent 440 can be changes to production levels of a certain product or products, the acquisition or divestment of a certain product or products, or a change in the prioritization of the delivery product or products. Additional actions that can be recommended by the reinforcement learning agent 440 can be changes to different features of the supply chain network such that a certain result is obtained with respect to a certain product or products.

In some implementations, the supply chain analysis platform 402 and reinforcement learning agent 440 can supplement input received from the large language model 430 with state information 820. State information 820 describes certain aspects of the existing supply chain network. For example, state information 820 can include an inventory level of a certain product, an existing contract for a certain number or products, or other known variables associated with a supply chain feature or product. State information 820 can be used as additional constraints that the reinforcement learning agent 440 can evaluate when recommending certain actions in the supply chain network.

After evaluating the input from the large language model 430 and state information 820, the reinforcement learning agent 440 can recommend one or more binned actions 830. A “binned” action 830 represents a compression of an action representation that results from the aggregation of product description 815 language embeddings. For example, the large language model 430 can generate a language embedding for product descriptions 815 that all have “shirt” identifiers, and recommend an action that would apply to everything in the resulting aggregation. In this example, language embeddings can be created that identify to the reinforcement learning agent 440 that the “red shirt” and “blue shirt” products can be treated similarly when recommending actions. This simplification can be performed at different levels of abstraction, for example, another aggregation for different sizes or shirts, or an aggregation for all products with a “clothing” label. A resulting binned action 830 could be a recommendation by the reinforcement learning agent to increase production of all “shirts,” or to change the delivery time or method for all products with the “shirt” identifier.

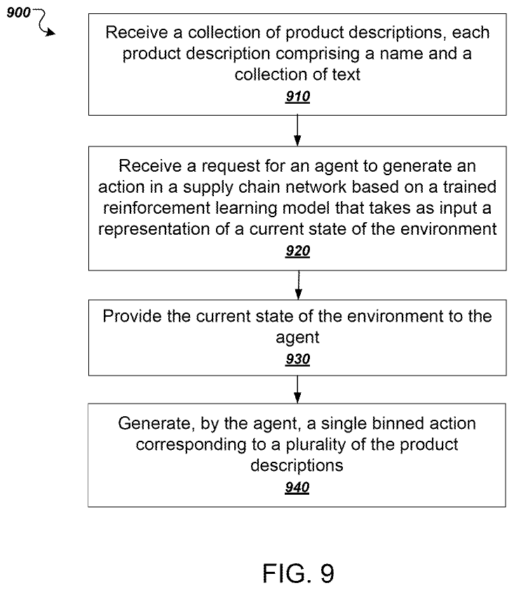

FIG. 9 illustrates a flowchart of an example process 900 for using a large language model to generate a binned action.

The process 900 includes receiving a collection of product descriptions, each product description comprising a name and a collection of text 910. Product descriptions can describe a function or category of a product. Examples of categories can be clothing, electronics, food, consumer products, or other distinguishable forms of goods. The abstraction of these product names can be varied, for example, a product description can be provided for a “shirt” and also a “red shirt.” These product descriptions can be used by a large language model to create language embeddings based on the name of the product and/or the collection of text.

The process 900 includes receiving a request for an agent to generate an action in a supply chain network based on a trained reinforcement learning model that takes as input a representation of a current state of the environment 920. The current state of the environment can include a prompt for an event, for example, an environment state change. The action requested from the agent can be associated with one or more of the product descriptions, the prompt provided to the agent, or both.

The process 900 includes providing the current state of the environment to the agent 930. The state of the environment can include one or more environment state changes determined by the large language model. This environment state change can be determined in a similar process as process 500 or 700.

The process 900 includes generating, by the agent, a single binned action corresponding to a plurality of the product descriptions 940. The binned action can be associated with one or more of the language embeddings, product descriptions, environment state changes, or a combination of the three.

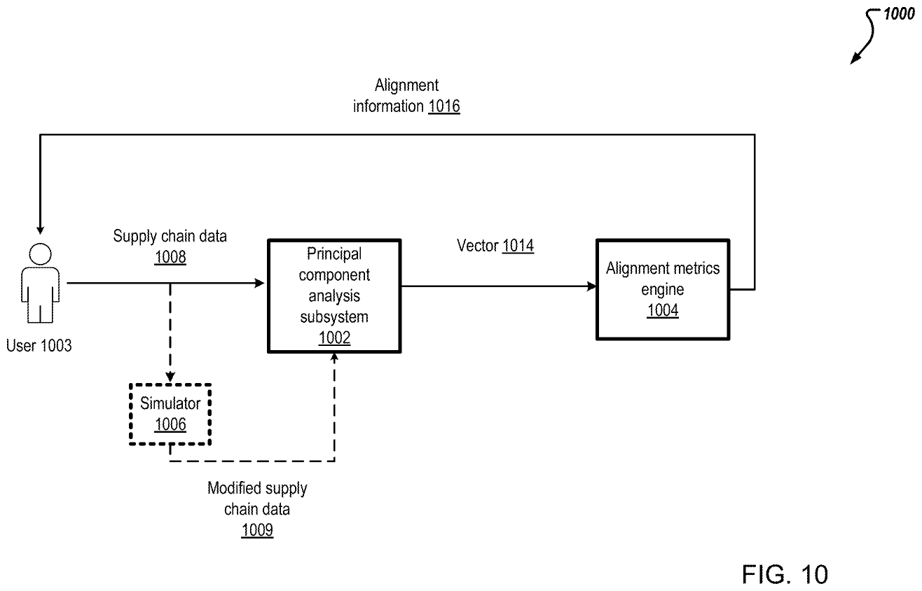

FIG. 10 is a diagram of an example system 1000 for generating alignment information of nodes in a supply chain. The system 1000 includes various components, such as a principal component analysis subsystem 1002, a user 1003, and an alignment metrics engine 1004. In some implementations, the system 1000 can also include a simulator 1006. In some implementations, the principal component analysis subsystem 1002, alignment metrics engine 1004, and simulator 1006 can be part of a same system and/or network of computing devices and/or systems.

The principal component analysis subsystem 1002 can be any appropriate type of computing device, computing system, cloud-based system, software, and/or network of computing devices/systems that performs principal component analysis. The principal component analysis generates a vector of principal components of given variables.

The example system 1000 includes a principal component analysis subsystem 1002 to perform principal component analysis, but in other implementations, the example system 1000 may use other techniques that identify dependencies between variables, such as copulas and time series analysis.

The alignment metrics engine 1004 can be any appropriate type of computing device, computing system, cloud-based system, software, and/or network of computing devices/systems that is configured to generate information representing alignment information of nodes of a supply chain given a vector resulting from a principal component analysis.

The simulator 1006 can be any appropriate type of computing device, computing system, cloud-based system, software, and/or network of computing devices/systems that is configured to perform simulations on supply chain networks.

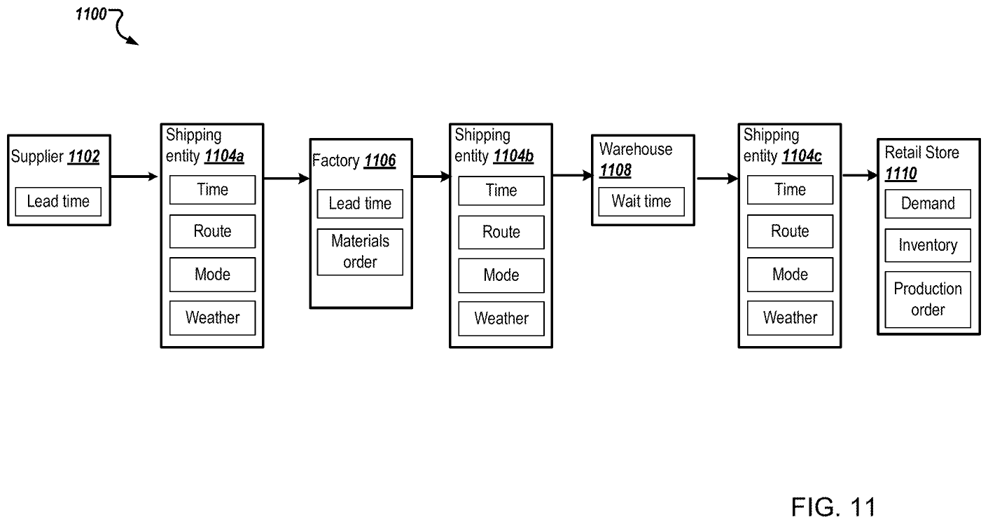

The principal component analysis subsystem 1002 can receive supply chain data 1008. The supply chain data 1008 can represent variables representing properties of a sequence of nodes in a supply chain. Each node can represent an entity involved in producing, transferring, or storing a product, e.g., suppliers, factories, shipping entities, warehouses, and retail stores. Properties of a sequence of nodes can include, for example, a lead time or a forecasted demand. A variable representing a property can include, for example, a value of 20 days for the lead time property. The supply chain data 1008 can include multiple values for each variable or property. The variables can reflect real-world data. For example, the values of the variables can be derived from observations. These observations can be derived from historical data about or compiled by a real-world entity. For example, the historical data can be a database of past transactions by an entity or weather conditions in a region near the entity. For example, the observations can include a list of past lead times for producing the product at a factory in the sequence of nodes of supply chain data 1008. In some implementations, the variables can reflect simulated data or be derived from simulations. An example of a sequence of nodes in a supply chain is shown below in FIG. 11.

The supply chain data 1008 can be provided by the user 1003 (e.g., relevant stakeholder in the supply chain) through a programming language or natural language interface presented at a computing device such as a user device (e.g., laptop, tablet, mobile phone, smart phone, or computer) of the user 1003.

In implementations where the system 1000 includes a simulator 1006, the simulator 1006 can receive the supply chain data 1008 and modify the supply chain data to generate modified supply chain data 1009. The simulator 1006 can simulate different conditions at nodes in the sequence of nodes in the supply chain that affect the values of variables, and concatenate new values to the supply chain data 1008. For example, the simulator 1006 can determine the new values using regression. For example, conditions can include weather and shipping conditions, and natural disasters, including but not limited to snowstorms, hurricanes, tornadoes, or other adverse or unexpected weather patterns. The conditions can also include, but are not limited to, shortages in supply and/or demand for various resources and/or products, currency fluctuations, employee strikes, employee shortages, other types of labor shortages, traffic and other transport conditions, and other atypical conditions in the operation of a supply chain. In some implementations, a simulation can include a combination of conditions. The simulator 1006 can simulate and add additional values to the supply chain data 1008 for one property at a time or multiple properties at a time.

For example, the simulator 1006 can simulate adverse weather patterns that affect the lead time. For example, if the supply chain data 1008 had values of a 20 day lead time, 10 day lead time, and 15 day lead time, the simulator 1006 can add additional values such as a 30 day lead time, 40 day lead time, and 45 day lead time.

The simulator 1006 can output the modified supply chain data 1009 to the principal component analysis subsystem 1002. For example, the modified supply chain data 1009 can include the received supply chain data 1008, based on observations, as well as the simulated supply chain data, based on simulated conditions.

The principal component analysis subsystem 1002 can perform principal component analysis, or another technique for identifying relationships between properties, on the variables of the supply chain data 1008. In some implementations, the principal component analysis subsystem 1002 can perform principal component analysis on the variables of the modified supply chain data 1009.

The principal component analysis subsystem 1002 can generate a vector 1014 of principal components from the principal component analysis. The principal components measure an amount of variation for each dimension, where each dimension corresponds to a property. For example, the principal component can be a value that is a fraction of the total variance represented by the particular dimension. The values of the principal components have a sum of one. The first element in the vector is the first principal component and measures the dominant direction of correlation. In some implementations, a larger principal component represents that the corresponding dimension represents more of the total variance.

The principal component analysis subsystem 1002 can output the vector 1014 to the alignment metrics engine 1004.

As an example, given supply chain data 1008 with properties A, B, C, D, and E, the principal component analysis subsystem 1002 can generate vector 1014 as (0.8, 0.2, 0, 0, 0).

The alignment metrics engine 1004 can receive the vector 1014 and analyze the vector to determine misaligned principal components. For example, the alignment metrics engine 1004 can determine that the second principal component of vector 1014, with the value 0.2, is misaligned.

In some implementations, the alignment metrics engine 1004 can compare the vector 1014 to a benchmark vector. For example, the alignment metrics engine 1004 can determine a measure of distance between the vector and a benchmark vector. The alignment metrics engine 1004 can compare the vector 1014 to an ideal vector or a maximum entropy vector, for example. The ideal vector can be defined as a vector where the first element is close to one and every remaining element has a value close to zero. The maximum entropy vector can be defined as a vector having a uniform distribution.

The alignment metrics engine 1004 can generate alignment information 1016 in response to determining the misaligned principal components in vector 1014. The alignment information can represent one or more misaligned properties of the nodes of the supply chain that contribute to the misaligned principal components. The alignment metrics engine 1004 can determine that a property contributed to the misaligned principal component by projecting back to the supply chain data 1008 to determine which axis or dimension out of all the dimensions is captured the most in the vector. In some implementations, the alignment information can also represent a measure of how misaligned the misaligned properties are.

The one or more misaligned properties can represent contributions to a time lag of information transmission along the sequence of nodes in supply chain data 1008. The alignment information can suggest, for example, that if properties have no relationship or do not covary with each other, then nodes are not coordinating information with each other, or that a node is not receiving information updates quickly enough to adjust to changes at other nodes.

Continuing from the example above, the second principal component of vector 1014 may represent a linear combination of A, B, C, D, and E. The alignment metrics engine 1004 can determine that the second principal component mostly captures B and C. Thus, the alignment metrics engine 1004 can determine that the misaligned properties are B and C.

The system 1000 can provide alignment information 1016 to the user device of the user 1003. For example, the system 1000 can transmit data representing the alignment information 1016 to the user device for display to the user 1003.

In some implementations, the alignment information 1016 can include alignment information for each misaligned property. In some implementations, the alignment information 1016 can provide a ranking of different statistically independent misalignments of the sequence in supply chain data 108 based on the degree of their variability. This allows a user to determine which supply chain node or segment should be corrected for better alignment.

In some implementations, the alignment information 1016 can also include recommendations for improving alignment of the supply chain using the information representing the one or more misaligned properties.

In implementations where the system 1000 includes a simulator 1006, the system 1000 can determine alignment information for the modified supply chain data 1009. The system 1000 can use the simulator 1006 to generate different versions of modified supply chain data 1009, and determine alignment information for each version of modified supply chain data 1009. In these implementations, the system 1000 can consolidate and summarize or compare the alignment information 1016 that is generated for each version of the modified supply chain data 1009 and provide this information to the user 1003.

FIG. 11 illustrates a block diagram of an example sequence 1100 of nodes in a supply chain. The sequence 1100 can represent a real-world sequence in a supply chain in which multiple entities interact in the supply chain. For example, the sequence 1100 can represent a path in a supply chain network.

Each node can represent an entity involved in producing, transporting, or storing a product. In the example sequence 1100, a supplier 1102 can supply materials to a factory 1106 through a shipping entity 1104a. The factory 1106 can produce or supply products that can be transported to a warehouse 1108 through a shipping entity 1104b. The warehouse 1108 can provide the products to a retail store 1110 through a shipping entity 1104c.

Each node can have associated properties, and each property can be represented by variables. Some of the variables can be state variables, and some of the variables can be action variables. State variables are determined by external conditions, for example, a lead time, inventory, a relevant state of the world such as a measure of weather conditions at a node, a wait time, a transit time, or a measure of forecasted demand. Action variables are variables that entities can define, such as a production order, a port, a shipping container, a batch size, a transportation mode, or a transportation route.

For example, the supplier 1102 can have a property of a lead time for obtaining and processing materials. The lead time can be represented by a variable having a value of a 20 day lead time, for example. The shipping entities 1104a, 1104b, and 1104c can have properties such as a transit time, transportation route, a transportation mode, or weather conditions along the transportation route. The properties can be represented by variables with values such as a 10 hour transit time, or variables that represent the transportation route, mode, and weather conditions along the transportation route. The factory 1106 can have properties such as a lead time for producing the product or a materials order. The properties can be represented by variables having values such as a 10 day lead time, or a materials order for 10 units of material, for example. The warehouse 1108 can have a property of a wait time for holding the product at a port, for example. The wait time can be represented by a variable having a value of a 10 day wait time, for example. The warehouse 1108 can also have properties such as capacity, storage costs, available quantity of the product, arriving shipment order, return quantity, etc. The retail store 1110 can have properties such as forecasted demand for the product, inventory of the product, and a production order. The properties can be represented by variables with values such as a measure for forecasted demand of 50 products, an inventory of 100 products, and a production order of 500 products.

Information representing one or more misaligned properties of the nodes can, for example, be discovered and provided to a user through performing principal component analysis and generating alignment information. A system, such as the system 1000 of FIG. 10, can generate alignment information for the data representing the sequence 1100 of nodes. For example, the system can use component analysis subsystem 1002 as described in FIG. 10. The system can generate alignment information for the sequence 1100 based on performing the principal component analysis. For example, the system can use an alignment metrics engine 1004 as described in FIG. 10.

For example, the values for the materials order property in the supply chain data for the sequence 1100, e.g., the historical data for materials orders at previous times at factory 1106, may all have the same value of 10 units of material. The values for the measure of demand property, e.g., the historical data for the measure of forecasted demand at the previous times at retail store 1110, may vary from 10 products to 100 products. The values for the production order property, e.g., the historical data for production orders at the previous times at retail store 1110, may vary from 10 products to 100 products, and roughly increase or decrease with the measure of demand.

In an aligned supply chain or a sequence where the nodes do not have misaligned properties, as the measure of demand for a product increases, the production order may also increase, and the materials order may also increase. In general, each property or variable may correlate with each other property or variable. In this example, the materials order property may be misaligned because it does not change with the other properties. Thus, this alignment information can suggest that the entities in the sequence 1100 are not coordinating information with factory 1106, or that factory 1106 is not receiving information updates quickly enough to adjust to changes at other entities such as retail store 1110 in the sequence 1100.

In some implementations, a system such as the system 1000 of FIG. 10 can modify the sequence 1100, for example, by changing or adding one or more values of one or more variables, using a simulator such as the simulator 1006 of FIG. 10.

FIG. 11 is merely an illustrative example of a sequence of nodes in a supply chain. There are many potential sequences of nodes in a supply chain, and many modified sequences of nodes for any given sequence of nodes.

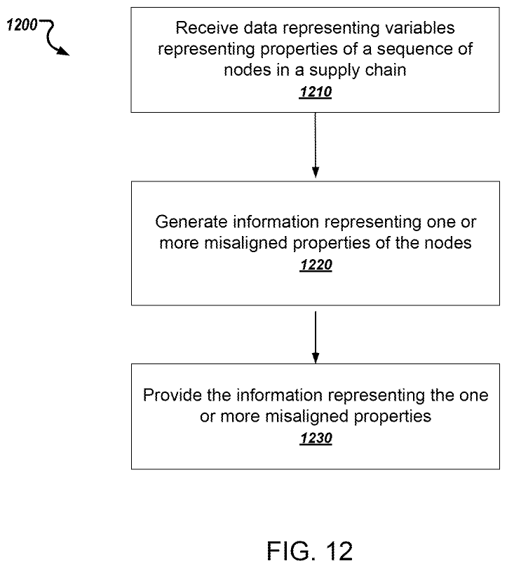

FIG. 12 is a flowchart of a process 1200 for generating alignment information of nodes in a supply chain. The process 1200 can be performed by any appropriate system of one or more computers in one or more locations, e.g., the system 1000 of FIG. 10.

The system can receive data representing variables representing properties of a sequence of nodes in a supply chain (1210). For example, the sequence of nodes in a supply chain can be the example sequence 1100 of FIG. 11. In some implementations, the system can perform simulations to generate the data. The generated data can represent different or additional values for variables than are represented in the received data.

The system can generate information representing one or more misaligned properties of the nodes of the supply chain (1220). For example, the system can perform principal component analysis to generate a vector including principal components of the variables. In some implementations, the principal component analysis includes a dimensionality reduction process that transforms the variables into orthogonal variables in a different coordinate space. The system can then analyze the vector to determine one or more misaligned principal components. The system can generate information representing one or more misaligned properties of the nodes of the supply chain that contribute to the one or more misaligned principal components.

The system can provide the information representing the one or more misaligned properties (1230). For example, the information can specify which of the properties is misaligned and/or a measure of how misaligned the properties are. The one or more misaligned properties can represent contributions to a time lag of information transmission along the sequence of nodes.

In some implementations, the system can also provide recommendations for improving alignment of the supply chain using the information representing the one or more misaligned properties. For example, the system may recommend adding a warehouse to a given region.

In some implementations, the system can also provide performance metrics of the supply chain using the information representing the one or more misaligned properties. For example, the system may provide an estimate of a cost or loss of an entity that the one or more misaligned properties contributes to.

In some implementations, such as where the system performs principal component analysis to generate a vector, the system can determine a measure of distance, or a supply chain alignment index, representing how close the vector is to a benchmark vector. For example, the benchmark vector can be a total entropy vector or an ideal vector. In some implementations, the system can compare the first element of the vector to one.

In some implementations, the system can compute a supply chain alignment index representing how close the vector is to a vector having a uniform distribution (i.e., a state of maximum entropy).

For example, the supply chain alignment index can be determined as:

$$SCAI = 1 - \frac{{\sum }_{i = I}^{N} {PCA}_{i} {log}_{2} ( {PCA}_{i} )}{{log}_{2} ( N )}$$

where N is the number of properties in the data and PCA is the N-dimensional vector.

In some implementations, the supply chain alignment index can be determined using Kullback-Leibler divergence between the vector and a benchmark vector of equal length.

In some implementations, such as where the system performs simulations to generate the data representing variables, the system can modify the data by modifying one or more values of one or more variables. In some implementations, the system can concatenate the modified values to the data. The system can then perform principal component analysis on the modified data to generate a second vector of principal components for the modified data. The system can compute a second supply chain alignment index for the second vector, and compare the second supply chain alignment index to the supply chain alignment index.

In some implementations, the system can rank the data using the supply chain alignment index and the second supply chain alignment index.

In some implementations, the system can perform multiple simulations to generate data, generate multiple vectors of principal components, compute supply chain alignment indices for each vector, and rank the data using the corresponding supply chain alignment indices.

In some implementations, the system can receive data for a sequence of nodes at multiple points in time, generate a supply chain alignment index for the data at each point in time, and generate information representing how the supply chain alignment index for the sequence of nodes changes over time.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, by a supply chain analysis system, a plurality of messages from entities in a supply chain network having a plurality of entities;
providing, by the supply chain analysis system, each message to a large language model that is configured to generate modified messages that are in a standardized format, wherein the standardized format includes one or more data elements representing a proposed exchange in the supply chain network; and
providing, by the supply chain analysis system, the standardized messages to one or more of the entities in the supply chain network to effectuate a communications interface through the large language model for entities in the supply chain network.

2. The method of claim 1, wherein the standardized format comprises raw text outputs.

3. The method of claim 1, wherein the large language model is configured to generate data elements representing a quantity of goods to be shipped or a unit price for shipping the goods.

4. The method of claim 1, wherein the large language model is configured to summarize the current state of the supply chain for all shippers and suppliers in the standardized format.

5. The method of claim 1, wherein the large language model is configured to generate data elements representing a quantity of raw materials requested by a factory or a unit price for purchasing the raw materials.

6. The method of claim 1, wherein the supply chain analysis system includes a machine-learned agent that is configured to generate recommended actions according to a state of the supply chain.

7-20. (canceled)

21. A system comprising:
one or more computers and one or more storage devices storing instructions that are operable, when executed by the one or more computers, to cause the one or more computers to perform operations comprising:
receiving, by a supply chain analysis system, a plurality of messages from entities in a supply chain network having a plurality of entities;
providing, by the supply chain analysis system, each message to a large language model that is configured to generate modified messages that are in a standardized format, wherein the standardized format includes one or more data elements representing a proposed exchange in the supply chain network; and
providing, by the supply chain analysis system, the standardized messages to one or more of the entities in the supply chain network to effectuate a communications interface through the large language model for entities in the supply chain network.

22. The system of claim 21, wherein the standardized format comprises raw text outputs.

23. The system of claim 21, wherein the large language model is configured to generate data elements representing a quantity of goods to be shipped or a unit price for shipping the goods.

24. The system of claim 21, wherein the large language model is configured to summarize the current state of the supply chain for all shippers and suppliers in the standardized format.

25. The system of claim 21, wherein the large language model is configured to generate data elements representing a quantity of raw materials requested by a factory or a unit price for purchasing the raw materials.

26. The system of claim 21, wherein the supply chain analysis system includes a machine-learned agent that is configured to generate recommended actions according to a state of the supply chain.

27. One or more non-transitory computer storage media encoded with computer program instructions that when executed by one or more computers cause the one or more computers to perform operations comprising:
receiving, by a supply chain analysis system, a plurality of messages from entities in a supply chain network having a plurality of entities;
providing, by the supply chain analysis system, each message to a large language model that is configured to generate modified messages that are in a standardized format, wherein the standardized format includes one or more data elements representing a proposed exchange in the supply chain network; and
providing, by the supply chain analysis system, the standardized messages to one or more of the entities in the supply chain network to effectuate a communications interface through the large language model for entities in the supply chain network.

28. The one or more computer storage media of claim 27, wherein the standardized format comprises raw text outputs.

29. The one or more computer storage media of claim 27, wherein the large language model is configured to generate data elements representing a quantity of goods to be shipped or a unit price for shipping the goods.

30. The one or more computer storage media of claim 27, wherein the large language model is configured to summarize the current state of the supply chain for all shippers and suppliers in the standardized format.

31. The one or more computer storage media of claim 27, wherein the large language model is configured to generate data elements representing a quantity of raw materials requested by a factory or a unit price for purchasing the raw materials.

32. The one or more computer storage media stem of claim 27, wherein the supply chain analysis system includes a machine-learned agent that is configured to generate recommended actions according to a state of the supply chain.
